(19) United States
(12) Patent Application Publication
(10) Pub. No.: US 2016/0283983 A1
(43) Pub. Date: Sep. 29, 2016

(54) METHOD AND APPARATUS FOR PROVIDING TARGETED ADVERTISING FEATURES TO PERSONAL SOCIAL NETWORKS

(71) Applicant: StoryCloud, Inc., San Diego, CA (US)

(72) Inventors: Kenneth J. KALB, Solana Beach, CA (US); Michael W. TRACY, Solana Beach, CA (US); Christina LIAO, San Diego, CA (US); Thomas H. BUSCHER, Los Angeles, CA (US)

(21) Appl. No.: 14/667,597

(22) Filed: Mar. 24, 2015

(51) Int. Cl. G06Q 30/02; G06Q 50/00

(52) U.S. Cl. CPC G06Q 30/0269; G06Q 30/0273; G06Q 50/01

(57) ABSTRACT

The system provides a method and apparatus for allowing the creation of customized private social networks through a dashboard interface. A user invokes the social network building interface and selects desired features for the network by selecting one of a plurality of possible features. When a feature is selected, the system guides the user through parameters and metrics to implement that feature as desired by the user. The system is implemented through a cloud based architecture that provides components that are used in the private social network, including services such as database, caching, load balancing, security, encryption, dynamic link control, and others. These services and components are accessed and invoked through a series of function calls through an API that allows the creation of a scalable number of private social networks.

### BACKGROUND OF THE SYSTEM

Social media networks have become ubiquitous in the present environment. Such networks are used by millions of users on computers, mobile devices, smart-phones, tablets, and other devices that are capable of interacting with a computer network such as the Internet. Many users have been frustrated by the way that social networks are currently implemented. It is often desired to utilize a social network for personal goals and to create one or more particular networks of friends and/or colleagues for specific users. However, using current technology it is difficult to achieve all the goals of a user. For example, it is difficult to create separate groups of friends and other users for specific purposes without overlap into other groups. For example, if a Facebook user desires to create different groups it generally requires the user to create multiple Facebook pages and to limit access to each page to specific desired users. Because of naming conventions and limitations in Facebook, it may be difficult to even name each page in the desired manner. In addition, each page may have more or fewer features than is desired for the intended purpose. The ability to customize the system for a desired purpose is limited.

Moreover, a large amount of analytical information can be gathered from various social network groups. However, there is no way to utilize this information in ways to promote more effective advertising and sponsorship opportunities that are targeted at multiple interested parties within the various groups. Moreover, no mechanism exists for interested parties to target specific groups by searching based on demographic information.

The inability to customize the system also leads to additional difficulties. For instance, social media corporate entities like Facebook implement various advertising and marketing schemes. These schemes are based on a number of different analytics that may be calculated. However, all profits from the advertising schemes benefit the corporate entity rather than the creator of the group that may have inspired the advertisement. Therefore, the ability to share advertising profits among members of the customized system is also limited.

### SUMMARY

The system provides a method and apparatus for allowing the creation of customized private social networks through a dashboard interface. A user invokes the social network building interface and selects desired features for the network by selecting one of a plurality of possible features. When a feature is selected, the system guides the user through parameters and metrics to implement that feature as desired by the user. The system is implemented through a cloud based architecture that provides components that are used in the private social network, including services such as database, caching, load balancing, security, encryption, dynamic link control, and others. These services and components are accessed and invoked through a series of function calls through an API that allows the creation of a scalable number of private social networks. The function calls define what features will be present in a private social network. The dynamic link control allows the network to control read and write privileges, permissions and other accesses for who, what, when, for how long and on what device, a particular piece of content or service will be available.

The system also provides a method and apparatus for providing targeted advertising to any of the private social networks in the system. The advertising network has the ability to access the system and target specific private social networks for advertising purposes. Such targeting may be done through a dashboard customized for the user. The advertisements can include several different features such as simple display ads, events, donations, and promotional discounts, to name a few. Additionally, advertisers may direct their target market to a customized link that describes the services that the advertiser can provide as well as the benefits of using the service. The system provides a mechanism for the private social network to realize at least some profit from the targeted marketing which, in turn, enables the administrator of the private social network to pass the profits onto his/her users (members). Essentially financial profits are contained within the private social network rather than only being realized by the system.

It is understood that other aspects of methods and apparatuses will become readily apparent to those skilled in the art from the following detailed description, wherein various aspects of apparatuses and methods are shown and described by way of illustration. As understood by one of ordinary skill in the art, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 is an example of a cloud of single purpose servers in an embodiment of the system.

FIG. 2 is an example of a single purpose server in an embodiment of the system.

FIGS. 3A-3D illustrate a mobile user interface in an embodiment of the system.

FIG. 4 is a flow diagram illustrating the creation of a PSN in an embodiment of the system.

FIG. 5 is a flow diagram illustrating the operation of the system in providing access to content via a link in one embodiment.

FIG. 6 is an exemplary embodiment of a data flow for targeting a PSN for an advertising campaign.

FIG. 7 illustrates an exemplary dashboard for advertisers to use to select and target specific PSNs based on a set of criteria.

FIG. 8 conceptually illustrates a process for targeting PSNs for certain advertising functions.

FIG. 9 illustrates an exemplary embodiment of the advertising features available to a selected PSN.

FIG. 10 illustrates an exemplary flow of data between the advertising network and a selected PSN.

FIG. 11 illustrates a exemplary embodiment of a detailed view of the selected PSN.

FIG. 12 conceptually illustrates a process for providing an advertising feature at a selected PSN.

FIG. 13 illustrates an exemplary device of some embodiments of the system.

FIG. 14 illustrates an exemplary data flow of some embodiments of the system.

FIG. 15 conceptually illustrates a process for passing profits from an advertising function to the users of the PSN.

FIG. 16 illustrates an administrative dashboard that may be used by and advertiser or advertising PSN.

FIG. 17 is an exemplary illustration of a member profile.

FIG. 18 illustrates an example of the sharing of content in one embodiment of the system.

FIG. 19 illustrates the display of a mobile device in one embodiment when content is accessed using the system.

FIG. 20 illustrates an embodiment of the system.

FIG. 21 illustrates an example computing environment of the system.

### DETAILED DESCRIPTION OF THE SYSTEM

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

System Embodiment

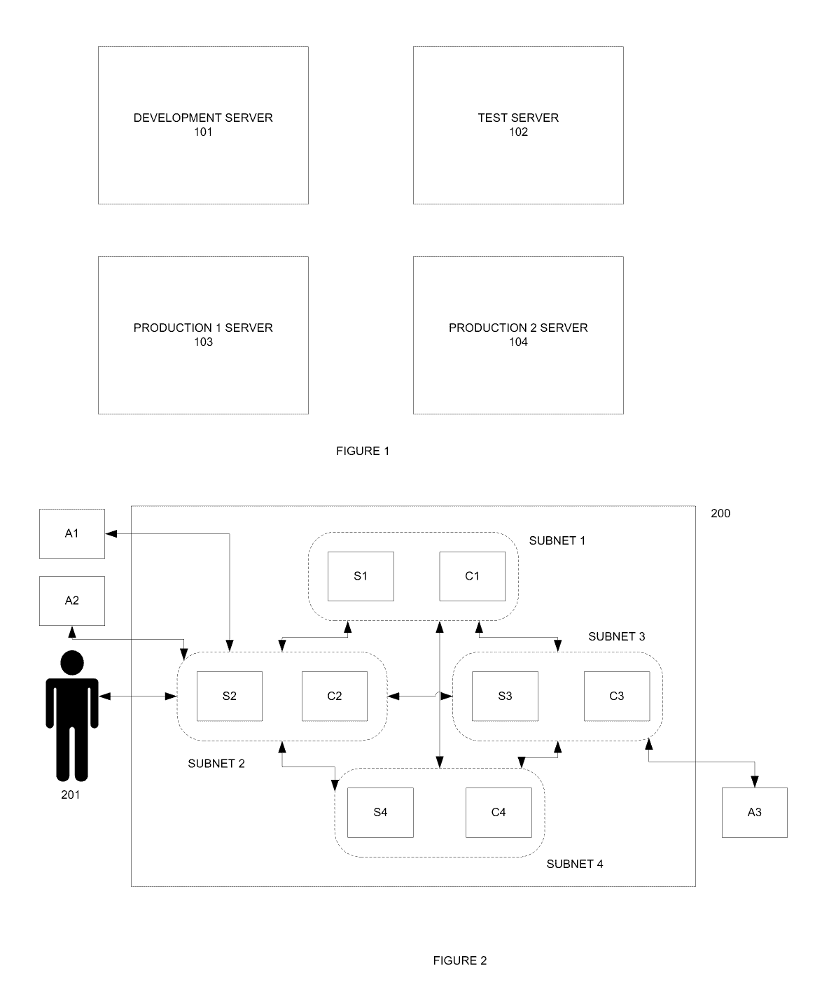

The system provides the ability for any user to easily create a private social network (PSN). The system is implemented through a cloud server based architecture having components that are used in developing, testing, and producing a scalable number of PSNs. FIG. 1 is an example of one embodiment of the architecture of the system.

FIG. 1 shows a cluster of single purposes servers including Development server 101, Test server 102, Production 1 Server 103 and Production 2 Server 104. The servers are implemented in the cloud and can be accessed through a network such as the Internet. The system is scalable such that any number of single purpose servers can be instantiated to provide the necessary services and functions to support the creation and management of PSNs. Although not shown in FIG. 1, each of the single purpose servers can communicate with third party applications as needed.

Each server cluster is a self contained entity using, for example, the Apache Hadoop system for storage and large scale processing of big data. Each cluster is capable of running approximately 1,000 machines. The server clusters may be implemented in, for example a cloud service such as Amazon Web Service (AWS). Each server cluster is virtually cordoned off in their own network separate from the other servers in the AWS. The system in one embodiment uses Java to control the database, APIs, and function calls. Redis is a caching application that is used in one embodiment. The system is easily scalable because a new server cluster can be cloned from an existing server cluster in a matter of moments. The creation of new server clusters may be driven by volume or performance. For example, it may be more useful to clone a new server cluster in a geographic location closer to a user base, including crossing international borders to provide more responsive service.

FIG. 2 illustrates the architecture of one example single purpose server. The single purpose server 200 is comprised of a plurality of subnets (Subnet 1-Subnet 4). Each subnet comprises a plurality of services S and clusters C such as services 51 and clusters C1 in Subnet 1, services S2 and clusters C2 is Subnet 2, services S3 and clusters C3 in Subnet 3, and services S4 and clusters C4 in Subnet 4.

The single purpose server 200 can communicate with users and with third party applications such as applications A1, A2, and A3. In one embodiment, application A3 may be an application controlling a PSN created by the system and is therefore considered to be “within” the PSN system. Applications A1 and A2 may be third party applications that are “outside” the PSN system but yet have access to, or may be accessed by, users within the PSN system. The third party applications could be public social networks that interact with the server 200 or it may be a service application (e.g. Amazon S3) that is associated with managing the cloud environment. The clusters may be implemented as virtual clusters using virtual machines (VMs). The VM may run Java or some other bytecode enabled system. The user of virtual clusters allows more scalability and live migration of memory and files, and dynamic deployment of additional virtual clusters as needed.

Each single purpose server 200 provides services in each such as database, caching, load balancing, security, encryption, dynamic link control, web server control, and storage and large-scale processing of data sets on clusters (e.g. Apache Hadoop) and others. These services and components are accessed and invoked through a series of function calls through an API that allows the creation of a scalable number of private social networks. The function calls define what features will be present in a private social network. The dynamic link control allows the network to control read and write privileges, permissions and other accesses for who, what, when, for how long and on what device, a particular piece of content or service will be available.

Each of the Subnets 1-4 can communicate with any of the other Subnets. Communication extends to the Services and Clusters within each Subnet. In one embodiment, one Subnet may provide security functions, including encryption, validation, permissions, and the like. Another Subnet may provide performance related functions such as memory management, caching, database control and the like. Another Subnet may provide operational functions such as communication, applet operation, Internet interface, and the like. Another Subnet may provide the functions and functionality that run the PSN.

PSN Creation

The system provides a method and apparatus for creating a private social network using an application. The result is an autonomous social network where the creator becomes the owner and/or administrator. In one embodiment, the system is implemented via a mobile app on a smart-phone, pad computer, tablet computer, or any other mobile computing device. The system may also be implemented on a desktop computer. Once created, the private social network can be accessed by any of the authorized users/members on any computing device that can access a network such as the Internet or other suitable network.

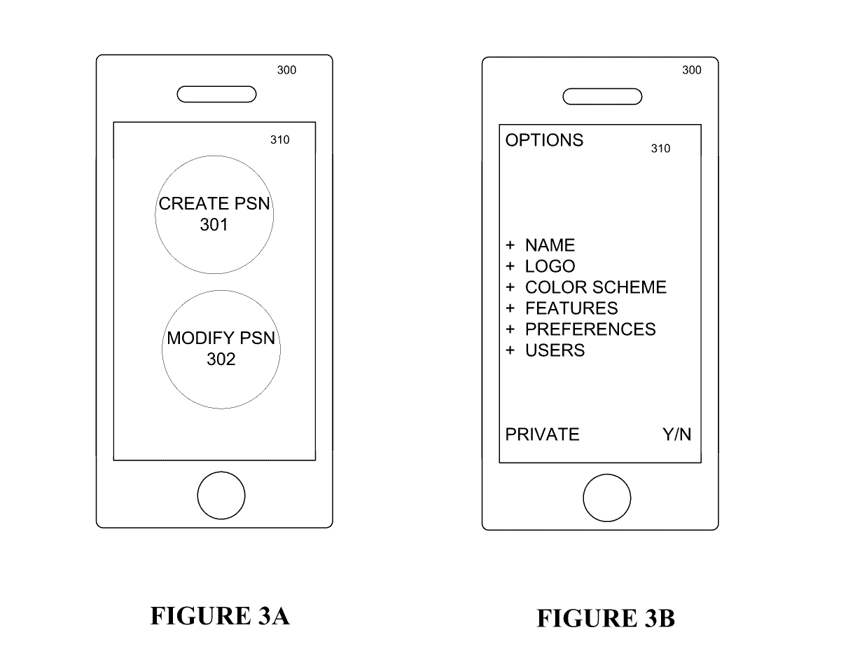

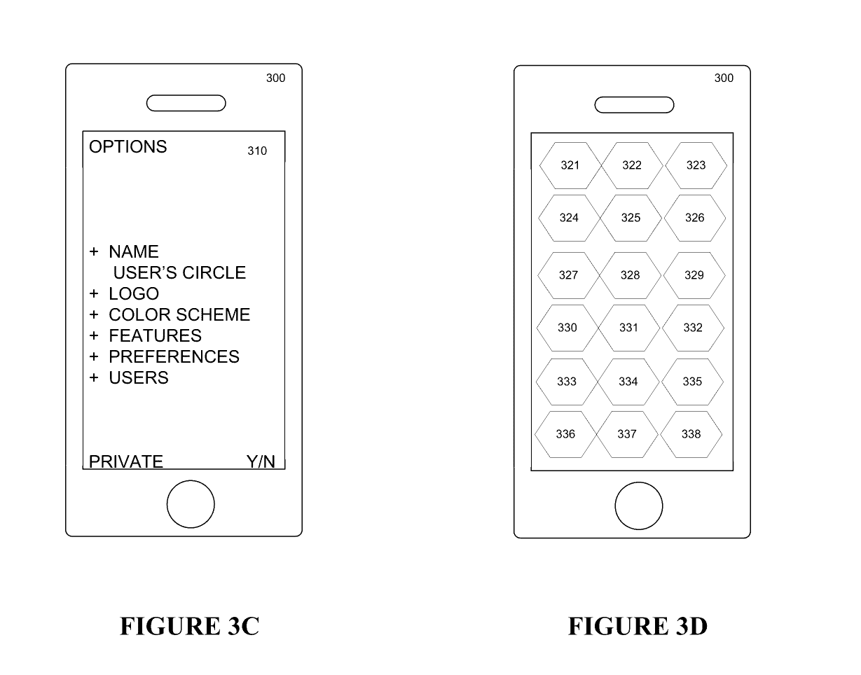

FIGS. 3A-3D illustrate an example of the user interface for the creation of a private social network on a mobile device in one embodiment of the system. Referring first to FIG. 3A, a smart-phone 300 includes a display region 310 that is typically a touch sensitive screen so that user input may be detected and converted into some action by the device. After the application is invoked, the user is presented with a choice to create a PSN 301 or to modify an existing PSN 302 The system contemplates the ability to create, manage, and modify a plurality of PSNs.

When the user has selected Create PSN 301, the display changes to that of FIG. 3B. The display 310 now presents a plurality of options that the user will select to define different aspects of the PSN. In one embodiment, the system or the user may have pre-defined default selections for some or all of the parameters, while in other cases, the owner will go through all of the options when creating a PSN. In the example shown, the system presents options for Name, Logo, Color Scheme, Features, Preferences, and Users. There is also a way to make the social network private or not as desired. In practice, all of the networks created using the system can be considered to be private social networks in the sense that they are created individually by each user. However, the PSN may allow some limited and controlled public access to non-users as a way of inviting additional users or for other purposes.

In one embodiment, each of the options includes “+” next to its identifying term to indicate that the selection of an option will present additional choices. For example, if the owner selects “Name”, the display will change to that as shown in FIG. 3C. When Name is selected, a text box is opened below the Name option and a keyboard is presented to the user (or a physical keyboard may be used). In the example shown, the owner has named the new PSN “User's Circle”. Being able to name your PSN is an advantage over prior art social networks.

When the owner selects Features, the display changes to that shown in FIG. 3D. FIG. 3D illustrates a plurality of features 321-338 that can be selected by tapping on the respective feature shape. Although 18 features are illustrated, the number of features can be changed and can be on one or more pages as desired. When a feature is selected, the color, shading, or border of the feature changes to show the owner that the feature has been selected. As shown in FIG. 3D, features 321 and 324 have been selected. Examples of features can be as follows in Table 1

TABLE 1

| PERMISSION 321 | STORAGE 322 | CALENDAR 323 |
|---|---|---|
| MAIL 324 | STORYLINE 325 | PUBLISHING 326 |
| SHARE 327 | MESSAGING 328 | PURCHASE 329 |
| ANALYTICS 330 | SETTINGS 331 | HISTORY 332 |
| EVENT/SCHEDULER 333 | PROJECT LISTS 334 | UPLOADER 335 |
| POLLS/VOTING 336 | CLASS/ACHIEVMENT | 338 |
| | 337 | |

These are given by way of example only, and other features may be presented without departing from the scope and spirit of the system.

Permission 321 provides options related to permissions. Storage 322 provides the ability to store PSN digital assets, to organize by tag of digital assets, and to organize by contributor/user. Calendar 323 is a shared calendar that can be used by the members of the PSN to identify events related to the group. Mail 324 provides a private and secure mail feature for the PSN, with the additional feature of being verified so that mail recipients can trust that the sender is a verified user. An example of the verified mail system is described in pending patent application Ser. No. 14/455,595 filed on Aug. 8, 2014.

Storyline 325 provides a member the ability to automatically build a narrative of activity associated with the member. The Storyline can be supplemented by other members via interaction with the member or by manually adding data to the Storyline of the member. Publishing 326 provides options relating to publishing. Share 327 provides options related to sharing.

Messaging 328 provides the ability for in-PSN messaging for the private social network. This feature can build an automatically populated messaging asset that can be used as an instant messenger or SMS type messaging system. Messaging 328 can be defined as 1 to 1 or group messaging. Purchase 329 provides the ability to handle financial transactions in the PSN. This activates a process that allows members to pay dues, donate to charity, handle financial transactions related to offers of sales to third parties, and the like. Analytics 330 provides statistical data associated with the PSN, and may be tied to activities of the members, purchasing information, and other analytical information that can be used to qualify the performance of the PSN.

Settings 331 provides options related to settings. History 332 provides the ability to keep a history of activity, messaging, and other data associated with the PSN. Event/Scheduler 333 allows a member to send invitations to other members and includes an RSVP function and possibly offers (e.g. raffle tickets, attendance fee handling, and the like). Project Lists 334 provides the ability to define a set of tasks, goals, or other items that can be associated with one or more members and also tied into the calendar feature to establish deadlines.

Uploader 335 is a feature that is invoked if the PSN is to allow digital assets to be transferred to shared storage of the PSN. Polls/Voting 336 provides the ability to define and present question and response to group members and to tally the results. Class/Achievement 337 provides the ability to associate the class or status of a member of the group with the accomplishment of activities defined in the PSN. Such status may be reflected by the offering of status badges, levels, icons, or other indicators of classification associated with achievements.

The Logo option allows the owner to select a graphic image that can be used as the logo for the PSN. This image may be from the owner's own image gallery, may be downloaded from a network, or may be a choice of logo's provided by the app and system.

The Color Scheme option presents the owner with a plurality of themes and color schemes that can be used with the PSN. In some cases, the owner can select a theme and then use a color picker to adjust colors of different aspects of the theme of the PSN.

The Preferences option presents various options for the owner to select for the operation of the PSN. For example, the owner may select preferences related to data presentation, sorting of posts, publishing options (including automatic publishing within and between other public and private social networks selected by the user, tying the PSN to other accounts, and other preferences).

The Users option is used by the owner to invite and/or validate members of the PSN. In one embodiment, the system can use a list of existing friends and connections of the owner in other system PSNs and/or other public or other social networks, address books, and the like.

The system allows an owner to create a PSN with only those features desired by the owner to be implemented in the PSN. For example, if the owner does not need the ability to purchase goods or services in the PSN, the user does not select the Purchase feature when creating the PSN. This gives great flexibility and adaptability to the owner in generating multiple PSNs. A PSN can be custom designed to fit its purpose in a way that is not possible in prior art social networks.

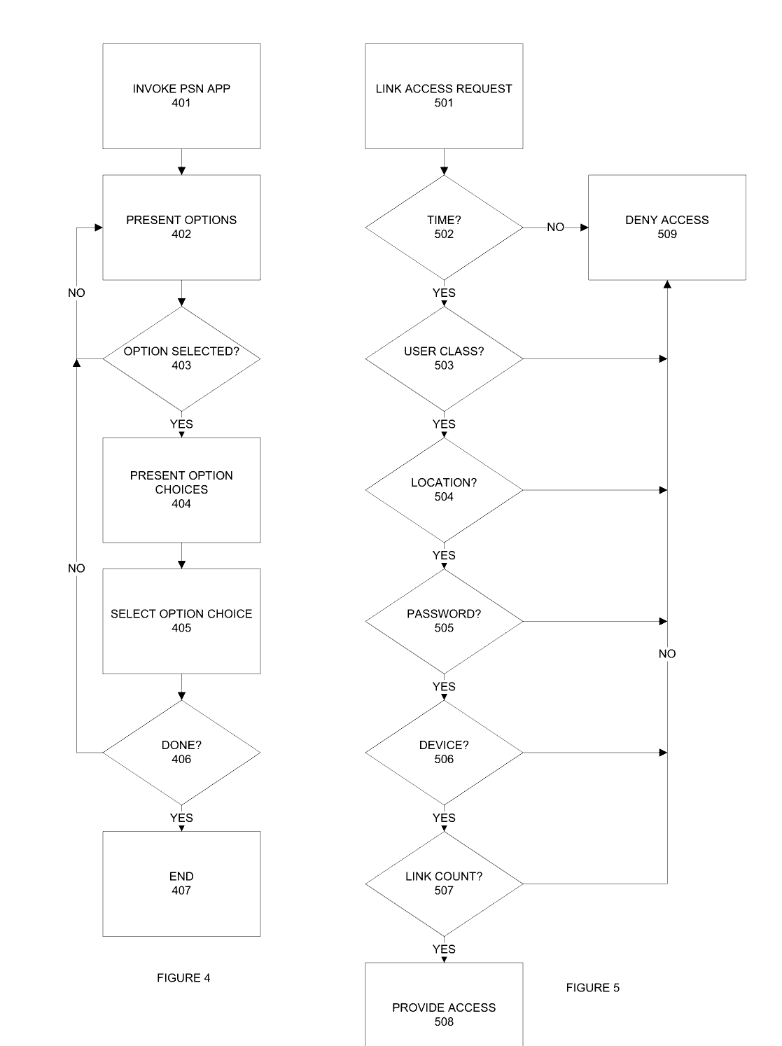

FIG. 4 is a flow diagram illustrating the generation of a PSN in one embodiment of the system. At step 401 an owner such as 201 in FIG. 2 invokes the Create PSN app on a computing device (e.g. a smart-phone). The invocation of the app on the computing device includes a connection to one or more of the single purpose servers in the cloud computing environment, such as server 200 of FIG. 2. In one embodiment, the selection of the options and features of the PSN takes place locally on the computing device and after all selections have been made, the build of the PSN takes place on the server 200.

At step 402 the system presents options to the user 201, such as those shown in FIG. 3B. At decision block 403 the system determines if an option has been selected. If not, the system returns to step 402. If so, the system presents the possible choices for the option at step 404. For example, if the owner has selected the Name option at step 403, the system shows a text field for entry of the name of the PSN as shown in FIG. 3C. If the owner has selected the Feature option at step 403, the system shows the Feature picker as shown in FIG. 3D.

At step 405, the owner makes a choice of the presented option (e.g. choosing a name or selecting one or more features, preferences, color schemes, selection of users, and the like). At decision block 406 it is determined if the owner is done creating the PSN. If so, the system ends at step 407. If not, the system returns to step 402.

In one embodiment, the features of the PSN are built locally on the owner's computing device and are then transmitted to the cloud where the PSN is formed based on the selections. In another embodiment, the owner's computing device is in connection with the cloud of servers and the PSN is built as the owner interacts with the PSN building application.

When a new PSN is built, the resources for running and managing the PSN are established in the cloud of single purpose servers and the PSN is available for user by the members of the PSN.

The ability to create and use PSNs provides use scenarios that are difficult or impossible to achieve using typical social media networks or existing tools. For example, a sports team can create a PSN just for their team. Team members can use the shared calendar and event scheduler to provide both passive and active notification of when and where the next game will be. The RSVP function helps confirm maximum participation.

A family can create a PSN just for the close family (e.g. parents and children). The family can coordinate their schedules, vacation plans, plays and other family events using the shared calendar and chat feature. Many children do not want their parents to be their “friends” on prior art social networks. A family PSN provides all the usefulness and tools of the social network without the perceived embarrassment of being online friends with a parent.

Additionally, PSNs can be used by marketing organizations to provide more targeted advertisements. Since PSNs are typically smaller and more customized, it is more likely that the users of a PSN will share a common interest. Thus, advertising agencies are enticed to use the analytics procured from the various PSNs and present targeted ad placement that is more likely to be successful.

PSN Specific Targeted Advertising

As discussed above, advertising agencies may wish to use some of the functionalities associated with PSNs to generate targeted advertising features that not only benefit the advertising agency, but also may provide financial compensation to the PSN administrator.

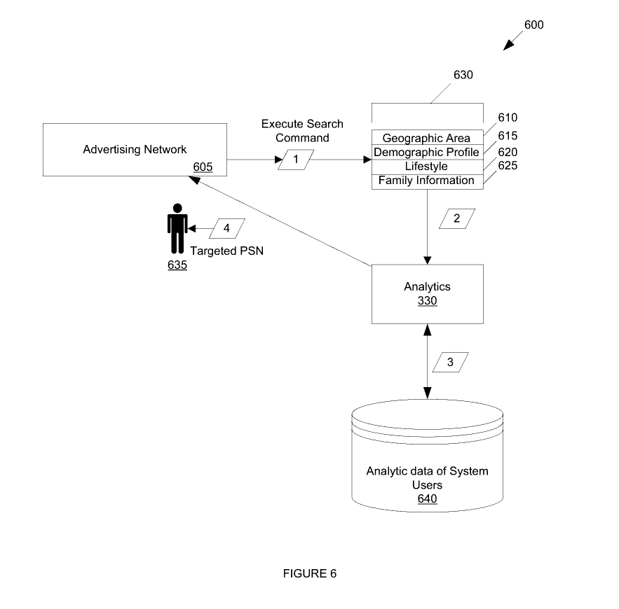

FIG. 6 is an exemplary embodiment of a data flow 600 for targeting a PSN for an advertising campaign. Data flow 600 includes an advertising network 605, PSN searchable attributes 630, Analytics engine 330, and an analytic data base of system users 640. The advertising network 605 may be capable of logging into the system for the purpose of collecting data on the variety of PSNs that are part of the system. The advertising network 605 may use the collected data to determine at least one PSN that would be a good target for the advertising network's campaign.

PSN searchable attributes 630 includes geographic area 610, demographic profile 615, lifestyle 620, and family information 625. The searchable attributes 630 illustrated in FIG. 6 illustrate a exemplary list of searchable attributes. A number of different searchable attributes may be available to the advertising network 605.

As shown, the advertising network 605 sends a data packet 1, which executes a search command using the searchable attributes 630. A data packet 2 is transmitted to the analytics engine 330 to determine which PSN(s) include the attributes desired by the advertising network. The analytics engine submits a request to the analytic data of system users database 640 to retrieve PSNs having the attributes desired by the advertising network. The analytics engine 330 receives a targeted PSN in data packet 3. The analytics engine 330 transmits the targeted PSN to the advertising network 605. As shown, the retrieved Targeted PSN is associated with an administrator 635. As will be described in greater detail in the foregoing sections, the targeted PSN administrator 635 may implement the advertising features available from the advertising network. The PSN administrator 635 could potentially be enticed to implement the advertising functions for the benefit of financial reward.

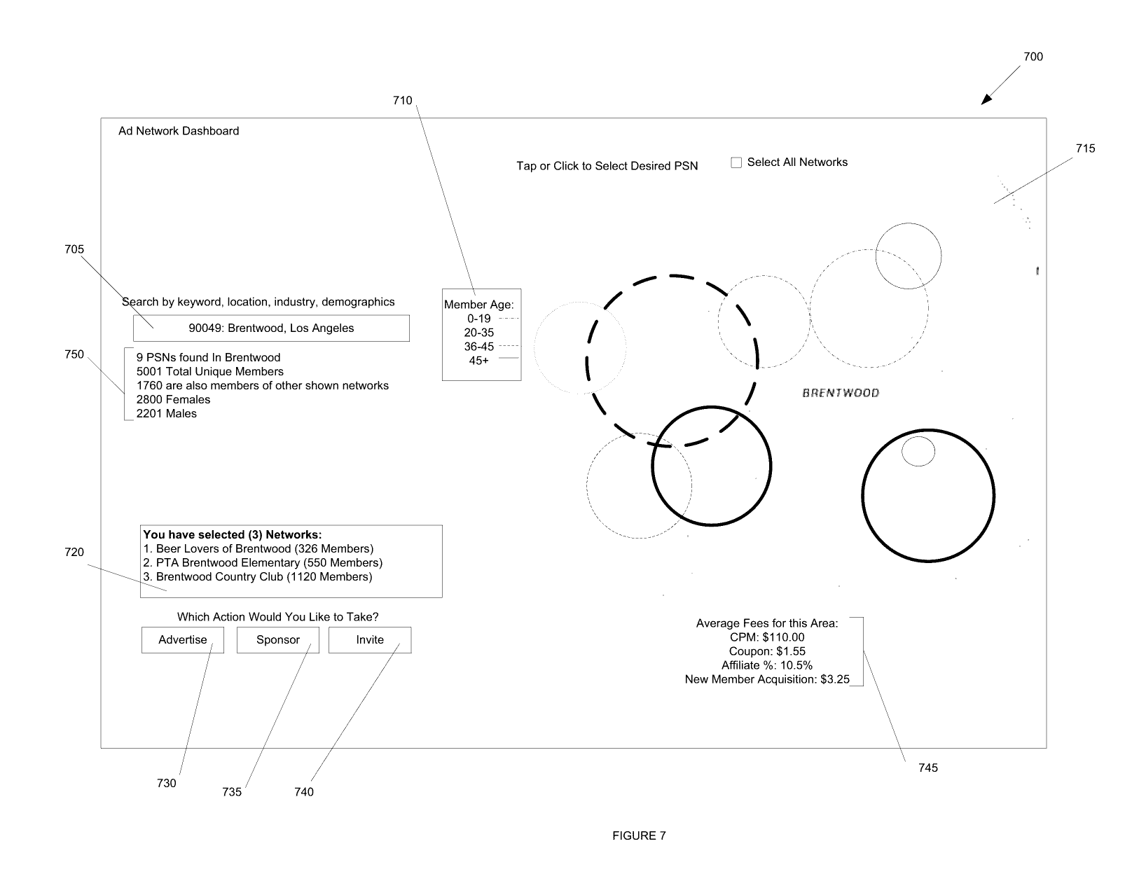

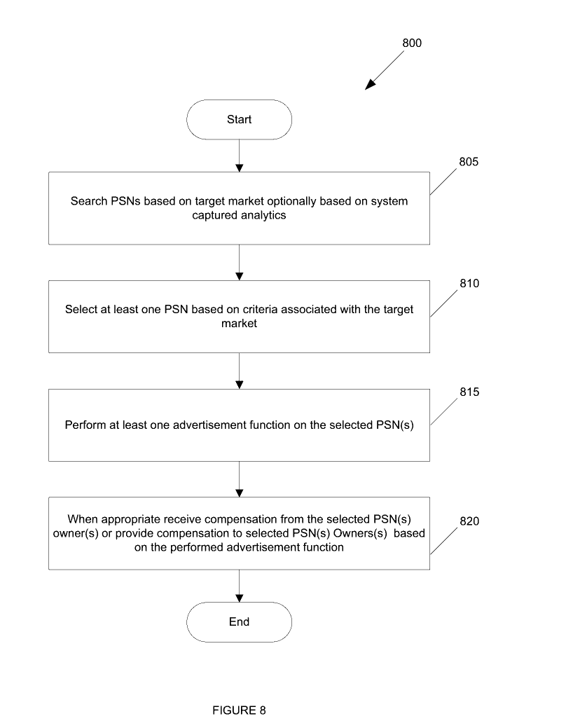

FIG. 7 illustrates an exemplary dashboard 700 for advertisers to use to select and target specific PSNs based on a set of criteria. As illustrated, advertisers may locate various PSNs by information such as location information, including city state, zip code, location radius, and country. Additionally, PSNs may be searched and/or filtered based on demographic information such as gender, age, marital status, number of children, car type, and ethnicity. The dashboard 700 may be provided when the advertising user logs into the advertising network's account.

As shown, dashboard 700 includes search area 705, demographic key 710, map 715, selected network information 720, selectable user interface (UI) objects 730-740, average fee information 745, and search criteria results 750. Dashboard 700 illustrates the results of entering a search string in the search area 705. In this exemplary illustration, the dashboard has received a location based search string. In return, the dashboard may provide the map 715 along with information such as the average fee information 745 for the area. Additionally the dashboard may provide demographic key 710. In this example, the demographics key is age based. However, the key may use any suitable way to distinguish the various PSNs.

The PSNs that are located based on the search string are represented on the map 715 by circles. In some instances, the circle may represent the size and/or geographic presence of the PSN. In such instances, size may be attributed to the number of members in the PSN. Additionally, the demographics key 710 helps to distinguish the age groups of each PSN, in this example. For instance, PSNs having members between the ages of 36-45 are represented by uniform dashed lines on the map.

In addition to the geographic information, the dashboard may also display the results of the PSNs that are within the searched geographic radius. For instance, the dashboard may display search criteria results 750. The search criteria results 750 may include the number of PSNs found in the location, the number of unique members to all PSNs within the area, the number of members that are members of more than one PSN represented on the map, as well as gender information. However, one of ordinary skill in the art will appreciate that the search criteria results 750 are not limited to the results illustrated in FIG. 7. Any suitable results may be displayed such as lifestyle information, income, type of cars owned, etc.

Once, the PSNs are shown on the map 715, the dashboard may receive a selection of at least one PSN. In this exemplary illustration, the dashboard has received a selection of three different PSNs. Those PSNs are illustrated in the box including selected network information 720. The selected network information may include the name of the network as well as the number of members in each network. Once at least one network has been selected, the dashboard may enable selectable UI objects 730-740 so that an advertising action may be taken on the selected PSNs. For instance, the dashboard may receive a selection of selectable UI object 730, which corresponds to performing an advertising function. Such advertising functions may include some of the functions discussed in the following description such as providing a coupon, promotional discount, or invitation to an event. Alternatively or conjunctively, the dashboard may receive a selection of selectable UI object 735 corresponding to sponsoring a PSN. For instance, the advertising PSN may wish to sponsor at least one of the selected networks by providing goods in exchange for marketing. Such goods may include equipment or t-shirts with company logos and/or slogans. Alternatively or conjunctively, the dashboard may receive a selection of selectable UI object 740 and invite the PSNs to join another PSN. The invitation may be to join the advertiser's PSN or a PSN associated with the advertiser. In such examples, the advertiser may be required to pay a fee for the privilege of inviting the PSN(s) to join. However, the fee may be worthwhile because it could drive additional business if the invitation is enticing.

The dashboard also provides additional information about the total cost to advertise to and range of ad revenue to be expected from the PSNs in the area and/or the selected PSNs. Such information may include average fee information 745 for the searched area. Such fee information may include cost per impression (CPM), coupon fees, affiliate percentage, and new member acquisition cost. This information may be useful to the advertiser in assessing whether it is worthwhile to invest resources in this particular geographic location. Additionally, if resources are invested, the advertiser has an idea of the cost and benefit of doing business in this region.

The dashboard provides an intuitive and straightforward mechanism for advertising PSNs to target the appropriate PSNs to promote its goods and/or services. Additionally, the dashboard may enable the advertising PSN to filter the search results based on additional criteria, or color code the PSNs. Such criteria may include whether the PSN is a social group, political group, cooking group, volunteer group, religious group or any other type of group joined together by a common bond. By providing such features, advertisers are able to estimate the total cost of advertising, sponsorship, and invitation costs per group or as an aggregate.

FIG. 8 conceptually illustrates a process 800 for targeting PSNs for certain advertising functions. The process 8 may be performed by an advertising network server such as the advertising network 605 described in FIG. 6. The process may begin after an advertising network operator has logged into the system. In some embodiments of the system, the advertising network may have a special account that indicates to the system and PSN administrators that the advertising network is different from the user generated PSNs.

As shown, the process 800 searches (at 805) PSNs based on a predetermined target market. In some instances, the process 800 may use the analytic data captured by the system while searching the PSNs. The process 800 may use different criteria, such as geographic location, demographics, lifestyle information, and family information while searching the PSNs to target the appropriate PSN(s) for marketing purposes. In some aspects of the process, the search may be completed by using the dashboard discussed above. The process 800 selects (at 810) at least one PSN based on the criteria associated with the target market. For instance, the process selects at least PSN by selecting one of the PSNs represented on the dashboard map. The process performs (at 815) at least one advertisement function on the selected PSN(s). Such advertising functions will be discussed in greater detail in the following sections. When appropriate, based on the advertising feature, the process 800 receives (at 820) compensation from the selected PSN(s) owner(s) or provides (at 820) compensation to the selected PSN(s) owner(s). The process then ends.

The advertising network selects at least one PSN based on the returned targeted PSNs. Once at least one PSN is selected, several advertising features or functions from the advertising network 605 become available to the selected PSN. Such functions may be displayed in a dashboard provided to the advertising PSN, which will be described in the foregoing.

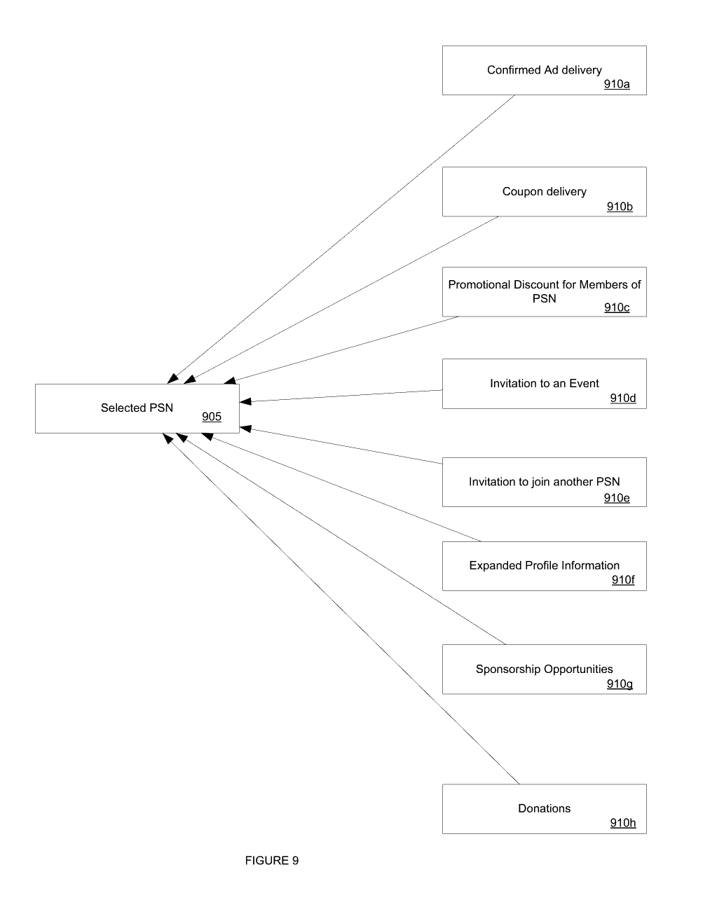

FIG. 9 illustrates an exemplary embodiment of the advertising features 910a-910h available to a selected PSN 905. The selected PSN 905 may select from the available advertising features 910a-910h. Alternatively, the advertising network 605 may only make a subset of the advertising features 910a-910h to the selected PSN 905. The advertising features 910a-910h illustrate an exemplary list of advertising options that may be available to the selected PSN 905. However, other advertising features not shown in FIG. 9 may be available to the selected PSN 905. Additionally, as will be discussed in greater detail below, the selected PSN may, in some instances, be granted the ability to collect a financial gain from implementing one of the advertising features. The selected PSN 905 may then choose to disseminate the financial gain to users of the PSN in the form of cash and/or prizes. Such an option gives the PSN administrator control over who profits from the advertising network, rather than the system. This harbors an environment that encourages the generation of additional PSNs and entices more advertisers to use the system, because each PSN may have a financial incentive to participate in the offered advertising features.

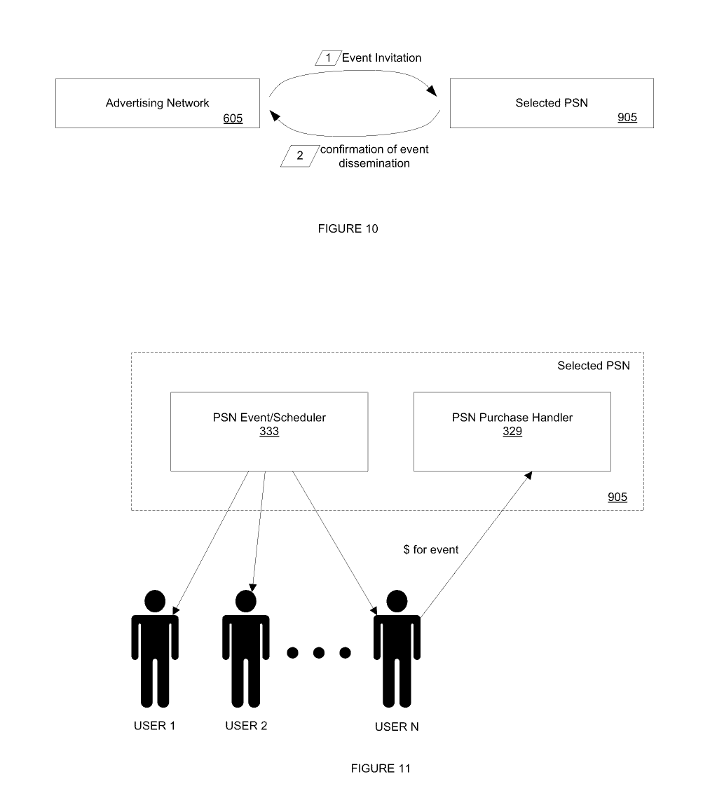

FIG. 10 illustrates an exemplary flow of data between the advertising network 605 and the selected PSN 905 described in FIGS. 6 and 9 respectively. In this exemplary data flow, the selected PSN 905 has chosen to participate in an event 910d advertising feature provided by the advertising PSN (or network) 605. As shown, the advertising network 605 transmits an event invitation in data packet 1 to the selected PSN 905. As will be discussed in the following figure, the selected PSN 905 may disseminate the event information to the users of the selected PSN. The selected PSN 905 may then optionally transmit a confirmation that the event information has been disseminated to the users of the selected PSN 905 in data packet 2. Once confirmation is received, the advertising network 605 may provide information about the event, or implement the event through the selected PSN 905 via an API. The owner of the advertising network may have used the dashboard described in the previous figure to target the selected PSN 905 and determine the cost for advertising the event to the users of the selected PSN 905. In this instance, the advertising PSN determined that the advertisement was worth the cost.

FIG. 11 illustrates a exemplary embodiment of a detailed view of the selected PSN 905. As shown, the selected PSN includes the PSN Event/Scheduler 333 and the PSN purchase handler 329. In this example, the selected PSN 905 includes USERS 1-N. As shown in this example, the PSN event/scheduler 333 disseminates the event information to the users of the selected PSN. A fee may optionally be attached to the event. Thus, a user may be required to pay a fee to participate in the event. The users of the selected PSN may view the event information and determine if they will participate in the event. As shown in this example, User N has decided to participate in the event by transmitting the fee to the PSN purchase handler 329. Once the fee has been transmitted from USER N, the selected PSN may maintain the collected fee. Alternatively or conjunctively, the selected PSN may pass on all or a portion of the fee to the advertising network. In this instance, the advertising network likely paid a fee to advertise the event to the selected PSN, so in this instance, the advertising PSN may utilize the resources provided in the dashboard described above to best determine whether the advertising costs will generate enough revenue from the selected PSN.

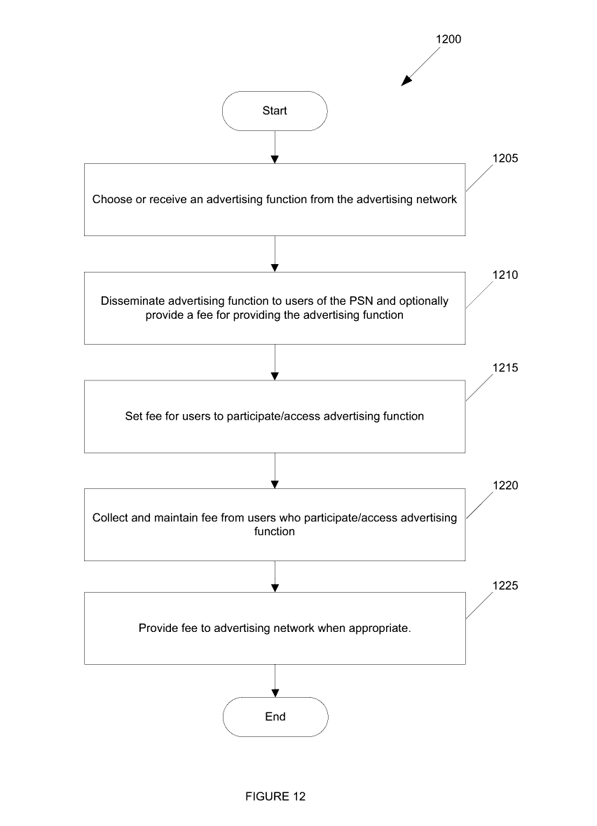

FIG. 12 conceptually illustrates a process 1200 for providing an advertising feature at a selected PSN. The process 1200 may be performed by a PSN such as the selected PSN described in FIG. 9. The process 1200 may begin after an advertising PSN has selected a PSN for targeted marketing. Such a selection process was described in detail with respect to FIG. 9.

As shown, the process 1200 chooses or receives (at 1205) an advertising function or feature from the advertising network. The process 1200 disseminates (at 1210) the advertising function to the users of the PSN optionally provides a requisite a fee for providing the advertising function. Such advertising functions were described in detail with respect to FIG. 9. The process sets (at 1215) a fee for users to participate and/or access the advertising function. Such a fee could be any value, including free ($0). The process collects and maintains (at 1220) the fee from the users who participate/access the advertising function. In some embodiments of the system, the collection and maintenance of fees may be skipped when participation in the advertising function is free. When appropriate, the process 1200 provides at least a portion of the fee to the advertising network. The process then ends.

In some aspects of the process, the advertising function may be one such as a sponsorship or invitation. In such aspects, the instead of collecting a fee, users may be provided with other benefits that may be financial or tangible gifts. For instance, a volleyball team may have created a PSN. A large manufacturer of sporting goods related to volleyball products may wish to sponsor the volleyball team. In such instances, rather than collecting a fee, the sporting goods manufacturer may send an elect to sponsor the team by providing financial assistance and other items such as athletic gear with the manufacturer's name. Additionally, for a fee, the advertising PSN may invite, for a fee, the selected PSN to join another PSN to receive more advertisements from a particular vendor.

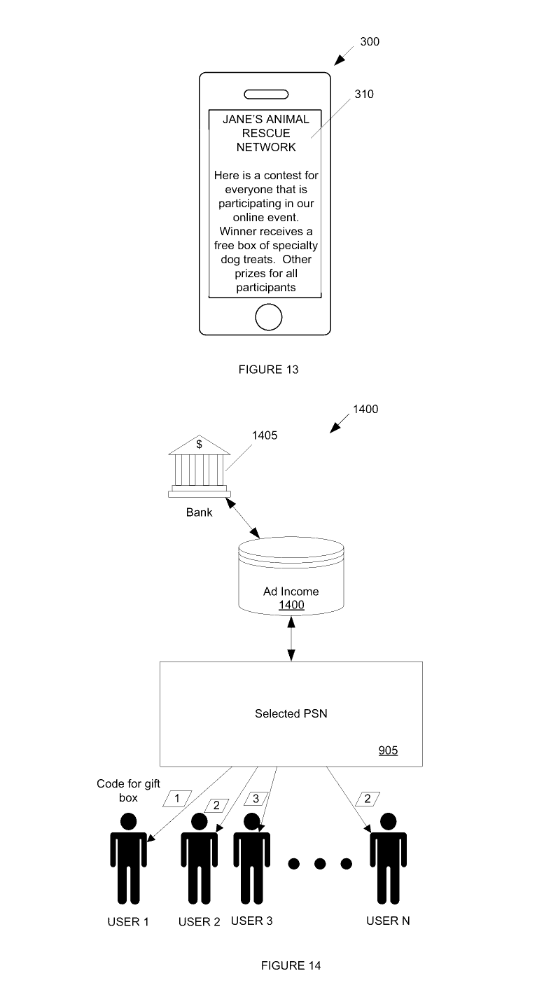

FIG. 13 illustrates an exemplary device 300 similar to the device 300 described with respect to FIG. 3. The device 300 includes the display area 310. The device 300 may be a device used by a user of an exemplary PSN. As shown, the display area 310 includes information about the exemplary PSN. Specifically, the display area 310 includes information indicating that the target audience for the particular PSN may be animal rescuers.

Display area 310 also includes information that may be disseminated from the PSN to the users indicating that this particular PSN is holding a contest to give back some of the revenue generated from the advertising features to the users of the PSN. The process in giving back the revenue may involve prizes, donations, cash rewards, or any other suitable option for providing valuable gifts to the users of the PSN.

FIG. 14 illustrates an exemplary data flow 1400. The exemplary data flow 1400 may be utilized during the process of returning some of the financial gains from using the advertising features of the advertising network to the users. In this example, USERs 1-N are participating in the contest. The USERs 1-N may be users using a device to communicate with the selected PSN 905. The selected PSN may communicate with an ad income database 1400 which maintains the information of all the revenue collected by the PSN through the targeted marketing features provided by the advertising network. The ad income database 1400 may be communicatively coupled to a third party bank 1405, where funds can be transferred to and from a bank account associated with the PSN. The funds may be transferred between the bank and the PSN by using an API associated with the bank and with the system such that the bank and system may communicate with each other.

As shown, USER 1 is given a code to receive a gift box in data packet 1. The code may be for a third party service that has worked out an arrangement with the PSN to provide the gift boxes to the users of the PSN. USERs 2, 3, and N received information about other rewards in data packets 2 and 3. Such rewards may be transferred to the user using any suitable means such as electronic mail, text message, or regular mail.

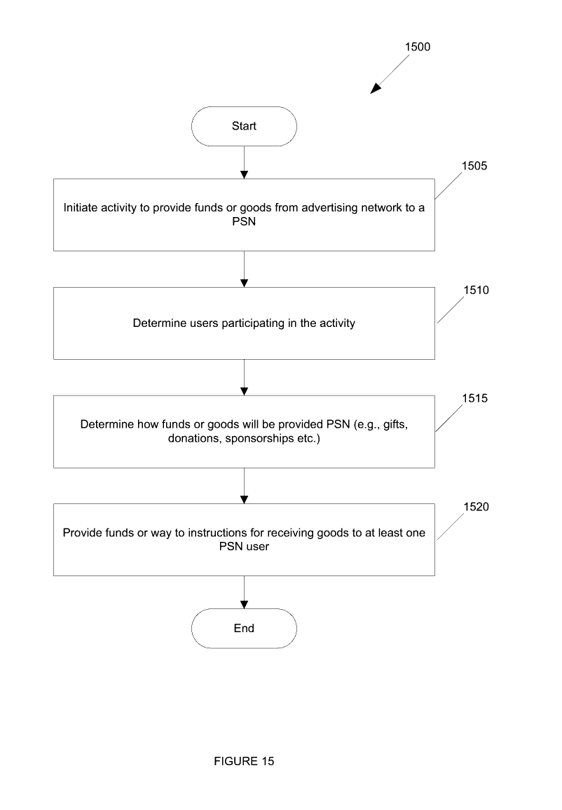

FIG. 15 conceptually illustrates a process 1500 for passing the profits from an advertising function to the users of the PSN. The process 1500 may be performed by a PSN such as the selected PSN described in FIG. 9. The process begins after a PSN has at least some fees or opportunities that can be distributed to users either in the form of cash, prizes, and/or sponsorship agreements.

As shown, the process 1500 initiates (at 1505) an activity to provide funds or goods from an advertising network to a PSN. When appropriate, the process 1500 determines (at 1510) the users that will be participating in the activity. Such a determination may be based on the number of users that respond to an alert transmitted by the system to announce that the activity is commencing, such as the alert illustrated in FIG. 12. However, in some aspects of the process only the PSN administrator may be responsible for accepting the advertising activity. Such instances may be when a PSN is invited to join another PSN, or when a PSN is offered a sponsorship opportunity.

The process 1500 determines (at 1515) how funds or goods will be provided to the PSN. For instance, the process 1500 may determine with the funds will be provided in the form of cash to certain users of the PSN, tangible items such as gifts, sponsorships and/or donations in the name of the user to a charity associated with the PSN. The process 1500 provides (at 1520) the funds to at least one of the participating PSN users based on the determination of how the funds are going to be provided. The process then ends.

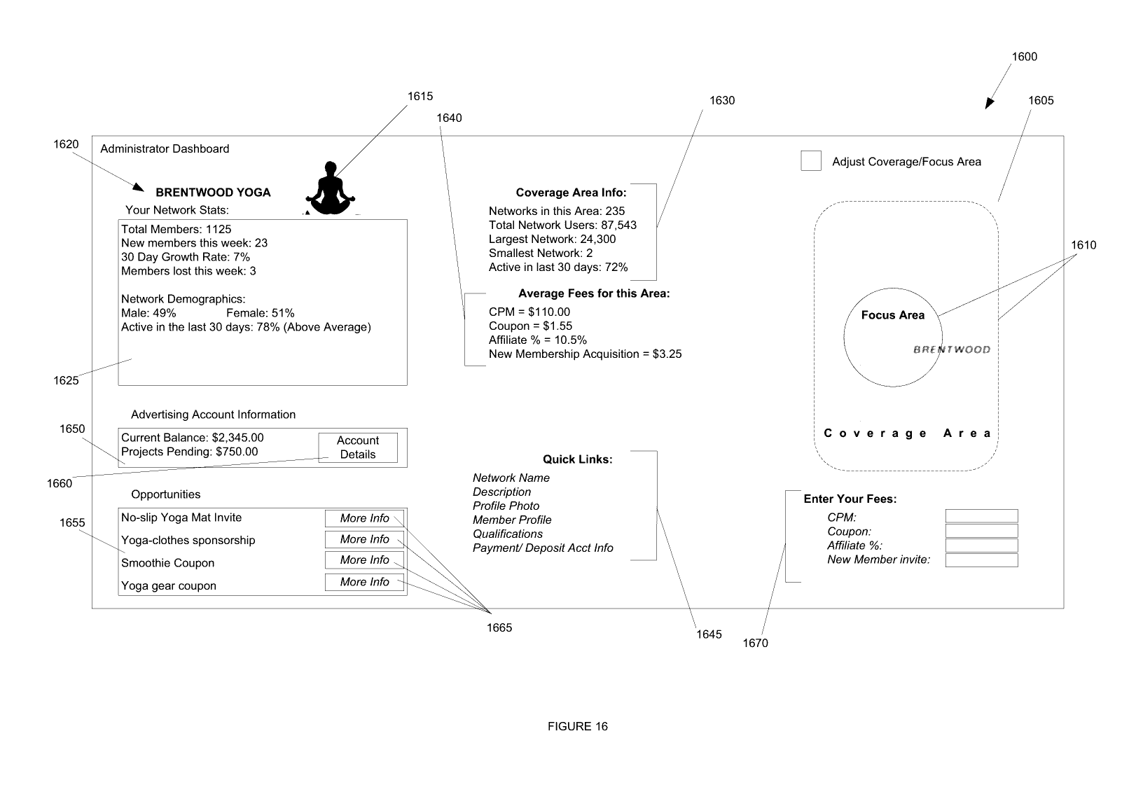

In some aspects of the system may provide advertisers with an administrative dashboard for monitoring and performing various administrative functions. For instance, the administrative dashboard may enable a PSN owner to set and actively pursue a desired target customer. FIG. 16 illustrates an administrative dashboard that may be used by and advertiser or advertising PSN. As shown, FIG. 16 includes the dashboard 1600, a map 1605, geographic regions of interest 1610, logo 1615, group name 1620, PSN statistics 1625, advertising account information 1650, advertising event opportunities 1655, selectable UI objects 1660 and 1665 and 1665, coverage area information 1630, average fees for the area 1640, quick links 1645, and fee information 1670.

As illustrated, the dashboard 1600 provides and exemplary view of a dashboard for group name 1620, Brentwood Yoga. Some aspects of the dashboard may also include a representative logo such as logo 1615. In the dashboard, the owner of the PSN is able to monitor PSN statistics 1625. For instance, the PSN owner is able to see how effective certain marketing campaigns have been in growing the business. Additionally, the owner may use the network statistics 1625 to determine what types of targeted marketing campaigns the owner may wish to pursue in the future. For instance, if the advertising PSN recently released a marketing campaign targeting men, and the PSN gained additional male members, the dashboard may assist in providing information that the marketing campaign was successful.

The dashboard 1600 includes a map 1605, which illustrates focus and coverage areas 1610. The focus and coverage areas 1610 are indicated by graphical representations on the map 1605. The dashboard provides coverage area information 1630, which also may assist PSN owners in determining future marketing campaigns. The coverage area information the number of users in the PSNs within the coverage area as well as demographic information about the PSNs in the coverage area. In addition to the coverage area information 1630, the dashboard also provides average fees 1640 for the coverage area. For instance the dashboard may provide information such as CPM, average coupon cost, affiliate percentage, and average cost of new member acquisition. Doing so provides effective feedback for the owner of an advertising PSN to determine how much to budget toward marketing and how to best target marketing campaigns.

As shown in the dashboard 700, advertising account information 1650 may also be provided along with selectable UI object 1660. The advertising account information may provide the current balance of funds as well as funds that are scheduled to be allocated to marketing. For instance, the scheduled funds may include a coupon that provided to several PSN users. In such instances, the advertising PSN charged for each download of the coupon. Thus, the scheduled funds (projects pending) may indicate funds that are tied up while the coupon campaign is ongoing. When the coupon campaign expires, whatever of the scheduled funds is left may be redistributed back to the account balance. The dashboard may provide additional account details upon receiving a selection of the selectable UI object 1660. Additionally, the dashboard 1600 may provide a daily, weekly, monthly, and/or total ad budget.

Additionally, the dashboard also provides opportunities that may have been presented to the advertising PSN. Such opportunities are illustrated in advertising event opportunities 1655. For instance, the PSN may have been provided certain coupons or sponsorship opportunities. The dashboard may provide additional information about the opportunities upon receiving a user interaction with one of the selectable UI objects 265.

The dashboard 1670 also provides the option for entering fee information 1670. The fee information may be entered in text boxes and the average fee information may be utilized to effectively determine the provided fee information to the dashboard 1600. Finally, the dashboard may also provide quick links 1645. The quick links may provide links to additional information about the PSN. For instance, the quick links may include a link to the PSN name, description, and account/payment information and profile information. The profile information may be a public link that the PSN owner may provide to external consumers who may wish to utilize the advertising PSN's resources.

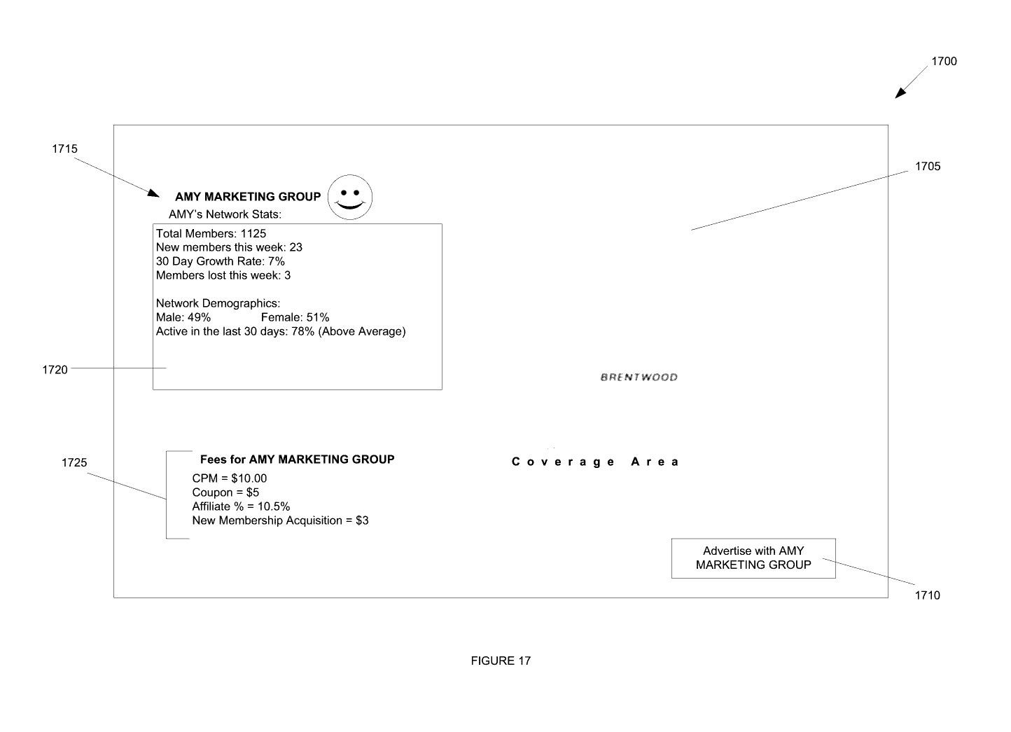

FIG. 17 is an exemplary illustration of a member profile 1700. The member profile includes a map 1705, PSN information 1715, PSN statistics 1630, and advertising fees 1725. In some aspects of the system, the PSN owner may provide a URL to access the member profile 1700, which may provide special services that a particular external business may use. The external business is then able to view the PSN statistics 1630, target geographic location according to map 1705 and fees 1725 for utilizing the PSN's services. Upon receiving a selection of selectable UI object 1710, the external business may then receive information for how to become a member of the PSN.

The foregoing description provides an effective and efficient mechanism for providing targeted and cost effective marketing. It also enables mechanisms for easily and effectively determining the cost of marketing and the demographics within a target market.

Controlled Data Access

In addition to the flexibility of creating a plurality of PSNs, the system includes additional protection for content that allows the owner of the content to determine and fully control who, what, where, and when/how long a content file is being shared. Whenever a member of a PSN links to content, they will have the ability to set granular controls, permissions, and limitations on the use and accessibility of the content or digital asset. In addition, the member can determine if the content will be sharable outside of a particular PSN, whether to other PSNs (e.g. application A3 of FIG. 1) or outside the PSN system (e.g. applications A1 or A2 of FIG. 1). Regardless of whether the content is to be shared within or without of the PSN system, the member can set limits to particular users, classes of users, or other access levels related to the content.

The content can be any digital asset including pictures, videos, documents, messages, and the like, and content can be accessible on devices, through the PSN, via the cloud, and the like.

The member of a PSN can set default options that may apply to all content that is created, with the member then adjusting settings as desired to provide more or less access to the content. Table 2 gives examples of the types of permissions that can be applied to content using the system.

TABLE 2

| | | | | PSN System |
|---|---|---|---|---|
| Start Time | End Time | Location | PSN Member | Member |
| Link Count | Modify File | Share Link | Analytics | Password |
| | | | | Protect |
| Repeat Views | Event Tie-in | Outsider | Device Limits | Financial |

The Start Time defines when the content will be available. This allows the user to set up permissions that will make content available in the future so that content can be scheduled in advance, without releasing the content. A link that is associated with the content will not operate if the Start Time has not yet occurred. The End Time defines when the access to the content will be terminated. The default for the Start Time may be that it is available upon uploading to the system and the End Time is open ended. The content owner is free to set any defaults for uploaded content. In one embodiment, the defaults may be tied to content type, with specific default profiles for text, audio files, video files, images, etc.

The Location setting may be used to set a geographical limitation on where the link to the content will be effective. For example, the content owner may only make the content link active at a specific location, such as a store, home, park, business, or the like. The system allows the owner to define a distance from a location in which the content link will be usable. The content owner may also limit access to the link to a PSN Member, a PSN system user, or it may be available to outsiders. The owner may require an outsider to register with the PSN system in order to be able to access the content link. In one embodiment, the content owner can access a map and use it to define a location at which content may be either viewable or prohibited, as desired. The user will also be able to use addresses, zip codes, or other location metadata to define protected geographical regions. Once a location has been determined, the content owner can use a slider or some other means to define the radius about which the content is available. In other embodiments, the user can define the region by drawing a boundary on the map, so that non-circular regions may be defined.

The Link Count can be used to set a number of times the link can be used to access the linked content. When the Link Count is exceeded, the link is rendered inactive. Repeat Views may be used to allow a user of the content link to use it more than once or to be limited to a single access. The Device Limits setting may be used to restrict access to the content link to a type of device either generically (e.g. a smart-phone), by producer (e.g. an Apple device), or even to restrict access to a single device, by tying access to a particular UDID or some other indicia that can be used to reliably identify a particular device. The link count can be bounded by number of impressions, unique views, particular user, time period, duration, and the like.

The content link may be password protected in that a person accessing the link will need to provide a password or respond to some other challenge before access to the link is given. The content owner can set the link to track and provide Analytics associated with use of the link, including identity of who accessed the link, how many times, for how long, and the like. The Share Link setting can be used to allow or restrict sharing of the link with others. If the link is sharable, all of the restrictions associated with the link stay with the link, so that protection is maintained.

The share link may be transmitted or communicated in any of a number of ways, including email, phone number, SMS, text, or any other suitable manner. The content

In some cases, the content owner may permit the user of the link to modify the content. This ability to modify the content may add another level of restrictions on who can modify, or it can apply to all users. The ability to modify can be parsed to one or more of a plurality of modification options, including overwriting, editing, adding audio, and the like.

The content link can have a connection to other events, such as a concert, sporting event, or other event, where the beginning and/or end of the event will define the accessibility of the content link. In one embodiment, the content link can have a financial component where a viewer may be required to pay for either viewing or to expand other permissions associated with the content link.

FIG. 5 is a flow diagram illustrating the operation of the system in providing access to content via a link in one embodiment. At step 501 someone makes a request to access the content link. At decision block 502 the system determines if the attempt to access the link is being made during the active time frame of the link. As noted above, this can be a fixed start and end period, or it may be tied to an event or some other time dependent trigger. If the access is not timely, the system denies access at step 509.

At decision block 503 the system determines if the user attempting access is in the approved user class as determined by the creator of the link. If so, the system proceeds, if not, access is denied. At decision block 504 it is determined if there is a location restriction and if so, if the user is within the designated geographic location for accessing the link. This may be determined by geo-location information provided by the access device of the user (e.g. smart-phone). At decision block 505, if there is a password requirement, the system requests it and checks for the proper password. If the password is not correct, the system may provide a certain number of retries. If the user fails to provide the password, access is denied.

At decision block 506 it is determined if there is a device requirement for access, and if so, whether the user is accessing the link on the correct device. This can be determined by IP address, UDID, MAC address, or some other reliable indicator of the device being used. At decision block 507 it is determined if the access request is within the number of allowed link requests. This number may be on a per-user limit or a total access limit for the link, as defined by the creator of the link. If the decision blocks are not satisfied, access is denied. If all are satisfied, the system provides access to the link at step 508.

When the viewer has access to the content, there are still restrictions associated with the content. The content is shared via the link, and is not resident on the viewer's device. Screenshot capability on the device is disabled to prevent the content from being captured by the device. Saving and forwarding the content is prohibited, although forwarding the link may be permitted. In some cases, the content may be modifiable by the user, depending on the permissions set by the content owner. In addition, the files will typically be encrypted to further provide protection.

The system allows the owner of content to have many levels of control and management over the content. By requiring all content to be accessed by link, the system allows a content owner to permanently remove content by eliminating the link to the content. This allows someone who posts a regrettable piece of content (unflattering picture, controversial post, and the like) to remove that content so that it is no longer accessible. This has advantages for content owners who want to sanitize their youthful exuberance and to present a more responsible face to employers, friends, relationships, and the like.

In one embodiment, the system implements the content links via and index node, referred to as an inode. The inode is a data structure that is used to represent an object (which can be any type of digital content). The inode includes attributes which can be used to characterize access to the referenced object, including access permissions, manipulation controls, and other content management metadata.

It is possible to have a plurality of inodes pointing to the same underlying data file (content). This allows the content owner to further customize access and manipulation possibilities of the underlying content. The content may be stored in “collection groups”. A particular content or resource may be found in more than one collection group.

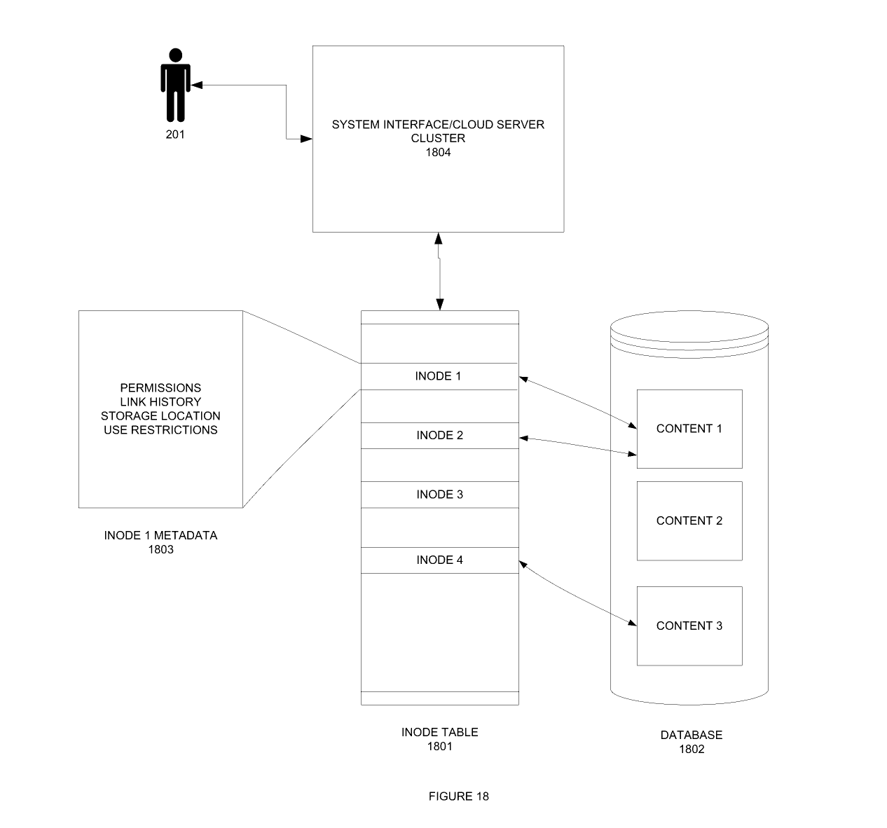

FIG. 18 illustrates an example of the sharing of content in one embodiment of the system. A user 201 attempts to access a content link by communicating in the system through a system interface (e.g. PSN) at system interface/cloud server cluster 1804. The server cluster 1804 includes an inode table 1801 that stores a plurality of links/inodes such as inodes 1-4. A database 1802 is coupled to the link table and stores a plurality of content, such as Content 1, Content 2, and Content 3.

Inode 1 is illustrated in more detail in inode 1 metadata block 1803. An inode includes permissions, link history, storage location of the content, use restrictions, and other metadata and control information that can be used by the content creator as described above.

As shown in FIG. 18, a particular content may be associated with one or more inodes. For example, Content 1 is associated with inode 1 and inode 2. Each inode can have its own associated permissions, access rules, modification rules, and the like. The content owner can create as many links or inodes to the same piece of content as desired, with each one being customized accordingly.

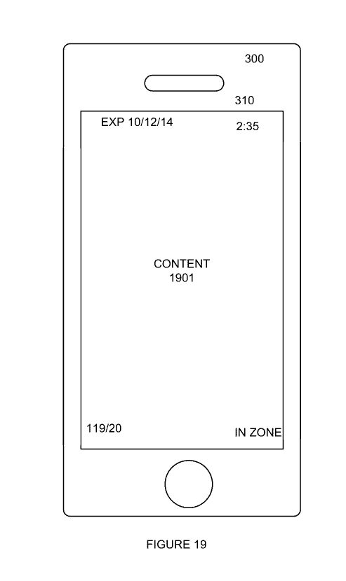

FIG. 19 illustrates the display of a mobile device in one embodiment when content is accessed using the system. The mobile device 300 displays the content 1901 on the display 301. The content can be image, video, audio, document and the like. On the top left of the display 301 the system displays the expiration date (if any) of the content. The top right illustrates a countdown timer to show how much longer the content 1901 may be viewed. This timer may refer to a current viewing session, an overall time limit associated with the content, an overall time limit associated with this particular viewer, and the like.

In the lower left of display 301, the system may display the number of views used and the total number of views available (e.g. this is the 17^{th} view out of 20 available). This may refer to the content for any user or it may refer to the content for this particular user. The lower right corner can be used to indicate if the user is in our out of the geo-location required (if any) for viewing the content. This is based on the device location and may or may not be a restriction, depending on the content owner.

Account Management

In one embodiment of the system, a user creates an account with the system and then can create multiple PSNs as desired. When the user invites members to a PSN, the system determines if the invited user is system member. If so, it can provide access to the PSN. If not, the system offers the opportunity to register in the system to the invited user and, after registering, the invited user becomes a member of the PSN.

An account may be family based, with a primary user and the right for other family members to create sub-accounts, or a specific number of PSNs. The system contemplates tiered pricing structures for various configurations, including number of PSNs, number of users, number of PSN members, and the like.

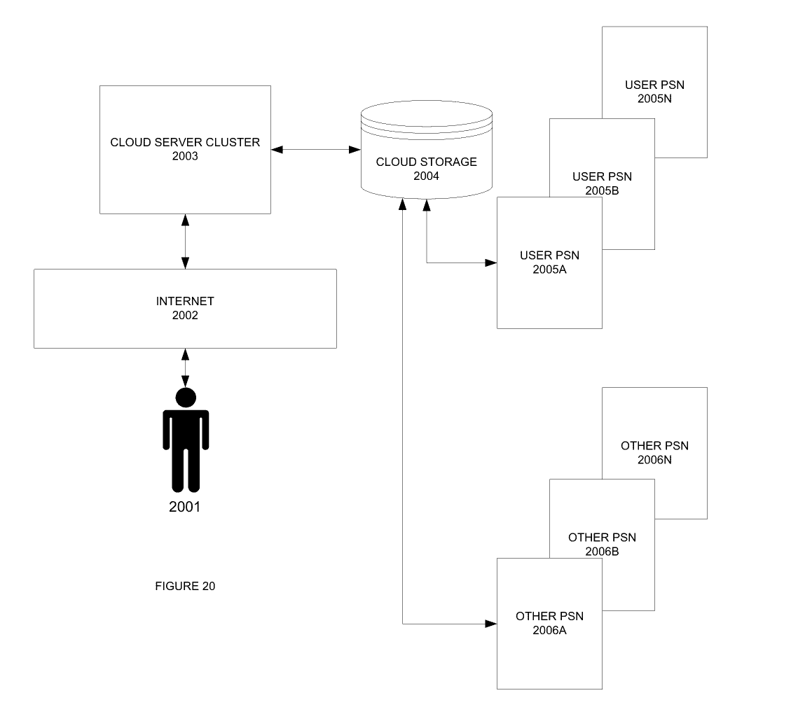

FIG. 20 illustrates an embodiment of the system. A user 2001 accesses the cloud server cluster 2003 via a network such as Internet 2002. The cloud server cluster 2003 interacts with cloud storage 2004 where data for the PSNs created and managed by user 2001 are stored. There may be a plurality of PSNs 2005A, 2005B, through 2005N, depending on how many PSNs the user has created. The user 2001 can also interact with other PSNs of which the user 2001 may be a member, such as PSN 2006A, 2006B, through 2006N.

Example Computer System

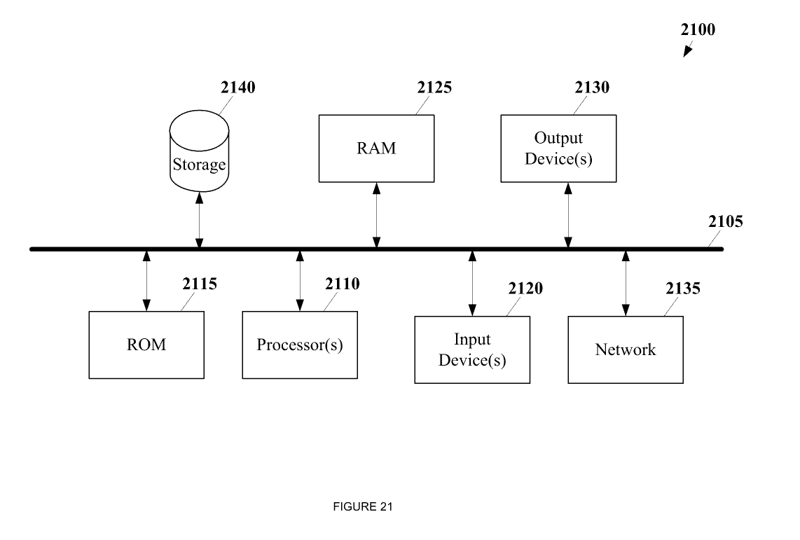

FIG. 21 illustrates an exemplary computer system 2100 that may implement the access controller and/or the access control device. The computer system includes various types of computer readable media and interfaces. The system includes a bus 2105, processors 2110, read only memory (ROM) 2115, input device(s) 2120, random access memory 2125), output device(s) 2130, a network component 2135, and a permanent storage device 2140.

The bus 2105 the communicatively connects the internal devices and/or components of the computer system. For instance, the bus 2105 communicatively connects the processor(s) 2110 with the ROM 2115, the RAM 2125, and the permanent storage 2140. The processor(s) 2110 retrieve instructions from the memory units to execute processes of the invention.

The ROM 2115 stores static instructions needed by the processor(s) 2110 and other components of the computer system. The ROM may store the instructions necessary for the processor to execute the web server, web application, or other web services. The permanent storage 2140 is a non-volatile memory that stores instructions and data when the computer system 2100 is on or off. The permanent storage 2140 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 2125 is a volatile read/write memory. The RAM 2125 stores instructions needed by the processor(s) 2110 at runtime. The bus 2105 also connects input and output devices 2120 and 2130. The input devices enable the user to communicate information and select commands to the computer system. The input devices 2120 may be a keyboard or a pointing device such as a mouse. The input devices 2120 may also be a touch screen display capable of receiving touch interactions. The output device(s) 2130 display images generated by the computer system. The output devices may include printers or display devices such as monitors.

The bus 2105 also couples the computer system to a network 2135. The computer system may be part of a local area network (LAN), a wide area network (WAN), the Internet, or an Intranet by using a network interface. The web service may be provided to the user through a web client, which receives information transmitted on the network 2135 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

1. A method comprising:
disseminating an advertising function to a private social network (PSN), wherein the PSN is selected to disseminate the advertising function based on a set of criteria for targeting specific PSNs; and;
receiving a fee from the users who accessed the advertising function.

2. The method of claim 1, further comprising setting a fee for users to access the advertising function.

3. The method of claim 2, wherein the fee is set to free.

4. The method of claim 2, wherein the fee is set to a value greater than 0.

5. The method of claim 4, further comprising maintaining the received fees from the users.

6. The method of claim 5, further comprising initiating an activity to return at least a portion of the received fees to users of the PSN.

7. A computer program product comprising a machine-readable medium comprising instructions executable to:
disseminate an advertising function to a private social network (PSN), wherein the PSN is selected to disseminate the advertising function based on a set of criteria for targeting specific PSNs; and;
receive a fee from the users who accessed the advertising function.

8. The method of claim 7, further comprising instructions executable to set a fee for users to access the advertising function.

9. The method of claim 8, wherein the fee is set to free.

10. The method of claim 8, wherein the fee is set to a value greater than 0.

11. The method of claim 10, further comprising instructions executable to maintain the received fees from the users.

12. The method of claim 11, further comprising instructions executable to initiate an activity to return at least a portion of the received fees to users of the PSN.

13. An apparatus comprising:
a processing unit configured to:
disseminate an advertising function to a private social network (PSN), wherein the PSN is selected to disseminate the advertising function based on a set of criteria for targeting specific PSNs; and;
receive a fee from the users who accessed the advertising function.

14. The method of claim 13, wherein the processor is further configured to set a fee for users to access the advertising function.

15. The method of claim 14, wherein the fee is set to free.

16. The method of claim 14, wherein the fee is set to a value greater than 0.

17. The method of claim 16, wherein the processor is further configured to maintain the received fees from the users.

18. The method of claim 17, wherein the processor is further configured to initiate an activity to return at least a portion of the received fees to users of the PSN.

19. A method comprising:
searching a plurality of private social networks (PSN) based on a target market;
selected a PSN based on at least one criteria associated with the target market; and
performing at least one advertising function the selected PSN.

20. The method of claim 19, wherein the criteria is at least one of geographic location, demographics, lifestyle, and family data.

21. The method of claim 20, wherein the criteria is determined by using analytics processed by a system that maintain the plurality of PSNs.
